(19) United States
(12) Patent Application Publication
(10) Pub. No.: US 2017/0177704 A1
(43) Pub. Date: Jun. 22, 2017

(54) SIMILARITY IN A STRUCTURED DATASET

(71) Applicant: Hewlett Packard Enterprise Development LP, Houston, TX (US)

(72) Inventors: Wei-Nchih Lee, Palo Alto, CA (US); Jerome Rolia, Kanata Ontario (CA)

(21) Appl. No.: 15/325,630

(22) PCT Filed: Jul. 29, 2014
(86) PCT No.: PCT/US14/48642

§ 371 Date: Jan. 11, 2017

(51) Int. Cl. G06F 17/30

(52) U.S. Cl. CPC G06F 17/30598; G06F 17/30569; G06F 17/30401

(57) ABSTRACT

Detecting similarity in a structured dataset is disclosed. One example is a system including a converter, and an evaluator. A structured dataset is received via a processing system, the dataset including a plurality of objects, each object of the plurality of objects associated with a category, and each category associated with an object label. The converter converts, for each object of the plurality of objects, the object label into a semantic term, The evaluator determines, via the processing system, a term similarity for a pair of object labels in a given category, the term similarity indicative of a correlation between the respective semantic terms in the given category.

### BACKGROUND

A dataset is a collection of data items. Datasets are analyzed to detect semantic similarities between the data items.

### BRIEF DESCRIPTION OF THE DRAWINGS

FIG. 1 is a functional block diagram illustrating one example of a system for detecting similarity in a structured dataset.

FIG. 2 is a flow diagram illustrating one example of a method for detecting similarity in a structured dataset.

FIG. 3 is a block diagram illustrating one example of a processing system for implementing the system for detecting similarity in a structured dataset.

FIG. 4 is a block diagram illustrating one example of a computer readable medium for detecting similarity in a structured dataset.

FIG. 5 is a flow diagram illustrating one example of a method for detecting similarity in a structured dataset.

### DETAILED DESCRIPTION

A dataset is a collection of data items. A structured dataset is a dataset where data items are described and organized based on inter-relationships between the data items. A relational database is an example of a structured database where the data items are formally described and organized based on a relational model. Datasets are analyzed to detect semantic similarities between the data items.

As described in various examples herein, similarity is detected in a structured dataset. Latent semantic analysis detects semantic similarity in an unstructured document. However, latent semantic analysis cannot analyze structured data like that found in relational databases. Latent semantic analysis cannot be applied to data items that represent continuously valued variables, such as age, number of purchases, dollar value of an item, health related data, and so forth.

As described herein, structured numeric data may be converted to semantic terms. For example, a plurality of individuals may be associated with their respective hemoglobin levels. Such levels may be represented by numeric data. In one example, a statistical distribution for hemoglobin levels may be identified, and based on the mean of such a distribution, a semantic term may be associated with each numeric value based the numeric value's distance from the mean. For example, numeric hemoglobin levels of 14.3, 20.0 and 5.2 may be converted to respective semantic terms such as “Hemoglobin::Normal”, “Hemoglobin::High”, and “Hemoglobin::VeryLow”. Latent semantic analysis (“LSA”) may be applied to the converted dataset.

As described in various examples herein, detecting similarity in a structured dataset is disclosed. One example is a system including a converter, and an evaluator. A structured dataset is received via a processing system, the dataset including a plurality of objects, each object of the plurality of objects associated with a category, and each category associated with an object label. The converter converts, for each object of the plurality of objects, the object label into a semantic term. The evaluator determines, via the processing system, a term similarity for a pair of object labels in a given category, the term similarity indicative of a correlation between the respective semantic terms in the given category.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

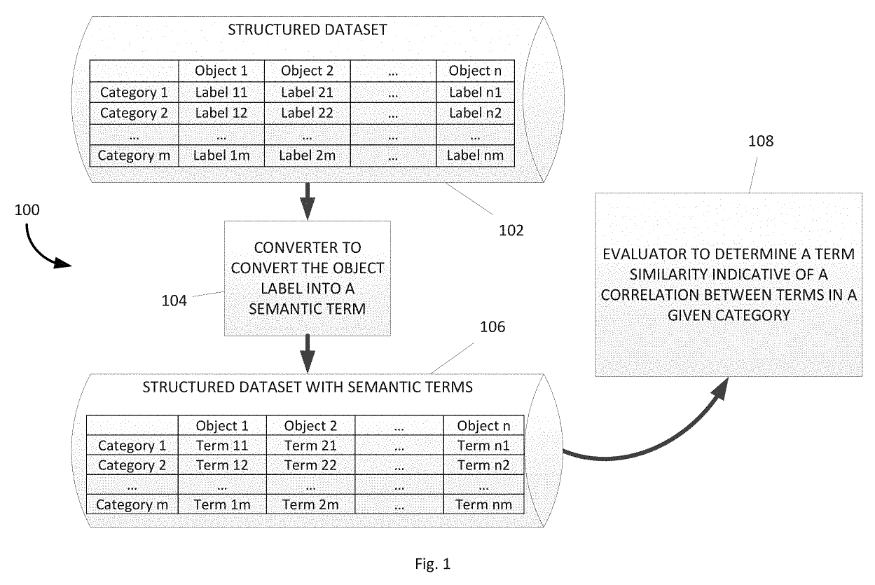

FIG. 1 is a functional block diagram illustrating one example of a system 100 for detecting similarity in a structured dataset. The system 100 receives a structured database, such as a relational database. The dataset may include a plurality of objects, with each object of the plurality of objects being associated with a category. The system 100 associates each category with an object label. The object label associated with each object is converted into a semantic term. The system 100 determines a term similarity for a pair of object labels in a given category, where the term similarity is indicative of a correlation between the respective semantic terms in the given category.

In one example, determining the term similarity may be based on LSA. LSA is a technique in natural language processing that analyzes relationships between documents based on semantics of terms appearing in the documents. Statistical approaches to document word frequencies may be utilized, LSA may be applied to unstructured data such as documents. Improvements to LSA, including probabilistic latent semantic indexing, and topic modeling with Latent Dirichlet Allocation, may also be utilized in determining the term similarity. As previously mentioned, these methods are applied towards document similarity and not to structured data with numerical values.

As indicated herein, latent semantic analysis cannot analyze structured data like that found in relational databases. Latent semantic analysis cannot be applied to data items that represent continuously valued variables, such as age, number of purchases, dollar value of an item, health related data, and so forth. However, the systems and methods described herein may be applied by any data scientist or analytics expert who uses high dimensional data to derive market actionable insights. For example, a marketing analyst performing customer segmentation may describe a customer in terms of demographics, buying behaviors, and interests. Alternatively, a hospital that wants to reduce re-admissions for heart failure may describe its patients based on their medications, laboratory procedures, and blood tests. In each case, the number of descriptive attributes measured can easily number in the hundreds if not thousands. Machine learning approaches to derive meaningful results may benefit from the approaches described herein to measuring term similarities. Also, for example, the systems and methods described herein may be applied to measure object similarities, and can measure similarity among objects in a dataset based on their common usage within a population.

System 100 includes a structured dataset 102, a converter 104, a converted structured dataset 106, and an evaluator 108. The structured database 102 may include a plurality of objects, such as Object 1, Object 2, Object n. Each object of the plurality of objects may be associated with a category, such as Category 1, Category 2, . . . , Category m. Each category may be associated with an object label. For example, as illustrated in the structured database 102, Object 1 may be associated with Category 1, and Category 1 may be associated with Label 11. Likewise, Object n may be associated with Category m, and Category m may be associated with Label nm. In one example, the structured dataset 102 may be a relational database. A relational database is an example of a structured database where the data items are formally described and organized based on a relational model. In one example, the structured dataset 102 may include data items that represent continuously valued variables, such as age, number of purchases, dollar value of an item, health related data, and so forth.

In one example, the structured dataset 102 may include numeric data. For example, the plurality of objects may be a plurality of individuals. Each individual may be associated with a category, such as blood pressure level, blood sugar level, hemoglobin level, and so forth. The object label associated with a category may be numeric values for the individual blood pressure level, blood sugar level, hemoglobin level, and so forth.

In one example, the structured dataset 102 may include non-numeric data, such as procedure data or binary data. For example, an individual may be associated with a category that comprises procedure data. The procedure data may be whether an individual has undergone a specific medical procedure, such as an open heart surgery, a kidney transplant, a removal of appendix, and so forth. Responses to such procedure data are object labels associated with each category. For example, the category may be “Open heart surgery performed?” and the associated object label may be a “Yes” or a “No” indicative of whether an open heart surgery was performed or not. In one example, the structured dataset 102 may include binary data, which includes any data that may be represented by a sequence of 0's and 1's.

Converter 104 converts the object label in structured dataset 102 to provide a semantic term suitable for processing by a natural language processor, such as LSA. In one example, the object label for each object of the plurality of objects is numeric data, and the converter converts the numeric data into the semantic term based on a statistical distribution of object labels associated with the plurality of objects. For example, the mean and standard deviation for each numeric data schema may be calculated. Generally, healthcare data may exhibit a wide range of values based on where the data is collected, the techniques used, the health care standards applied, and so forth. In one example, an entire population of healthcare data may be statistically analyzed to determine a mean and standard deviation.

For example, the entire population of healthcare data for blood sugar levels may be normally distributed. The normal distribution is symmetric about its mean and therefore facilitates a classification of individual data based on a distance from the mean. For example, 68% of values drawn from a normal distribution are within one standard deviation σ away from the mean μ. Accordingly, the object labels with numeric values in the interval [−σ, +σ] centered at μ may be associated with a semantic term “BloodSugar::Normal”. As another example, 95% of values drawn from a normal distribution are within two standard deviations 2σ away from the mean μ. Accordingly, the object labels with numeric values in the interval [σ, 2σ] may be associated with a semantic term “BloodSugar:High”, whereas the object labels with numeric values in the interval [−2σ, −σ] may be associated with a semantic term “BloodSugar::Low”. Finally, 99.7% of values drawn from a normal distribution are within three standard deviations 3σ away from the mean μ. Accordingly, the object labels with numeric values in the interval [2σ, 3σ] may be associated with a semantic term “BloodSugar::VeryHigh”, whereas the object labels with numeric values in the interval [−3σ, −2σ] may be associated with a semantic term “BloodSugar:VeryLow”.

The lack of whitespace between the category name “BloodSugar” and the semantic term “High” is necessary to ensure that the merged term, i.e. “BloodSugar::High”, is treated as one semantic term. Otherwise, a language processor may treat the terms “Blood”, “Sugar”, and “High” as separate terms, and may correlate these terms with other data categories or semantic terms, thereby adding noise to the data.

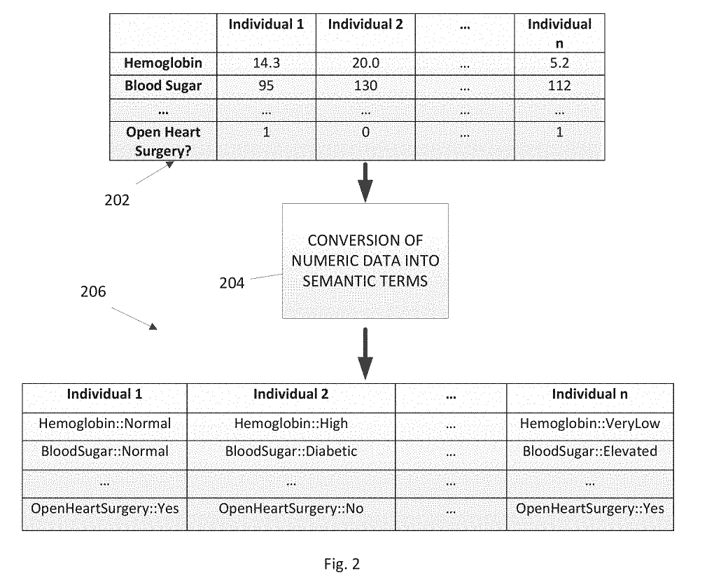

FIG. 2 is a flow diagram illustrating one example of a method for detecting similarity in a structured dataset. Structured dataset 202 is converted by converter 204 into a structured dataset with semantic terms 206. As illustrated, the plurality of objects may be a plurality of individuals, Individual 1, Individual 2, . . . , Individual n. Each object of the plurality of objects may be associated with a category. For example, the categories may be “Hemoglobin”, “Blood Sugar”, and a procedure such as “Open Heart Surgery?”. In one example, hemoglobin levels for men may be the object labels. For men, a range of 13.5 to 17.5 grams per deciliter may be statistically determined to be a normal range. Accordingly, Individual 1, with a hemoglobin level of 14.3 may be associated with a normal level of hemoglobin; Individual 2, with a hemoglobin level of 20.0 may be associated with a high level of hemoglobin; while Individual n, with a hemoglobin level of 5.2 may be associated with a very low level of hemoglobin. Based on such estimates, converter 204 converts numeric data into respective semantic terms. For example, the object label 14.3 associated with Individual 1 may be converted to a semantic term “Hemoglobin::Normal”; the object label 20.0 associated with Individual 2 may be converted to a semantic term “Hemoglobin::High”; and the object label 5.2 associated with Individual n may be converted to a semantic term “Hemoglobin::VeryLow”.

As another example, blood sugar levels may be the object labels. Blood sugar levels in a range of 90-110 milligrams per deciliter may be statistically determined to be normal; blood sugar levels in a range of 110-126 milligrams per deciliter may be statistically determined to be elevated; and blood sugar levels in a range of 126 milligrams per deciliter and higher may be statistically determined to be diabetic. Accordingly, Individual 1, with a blood sugar level of 95 may be associated with a normal level of blood sugar; Individual 2, with a blood sugar level of 130 may be associated with a diabetic blood sugar level; while Individual n, with a blood sugar level of 112 may be associated with an elevated blood sugar level. Based on such estimates, converter 204 converts numeric data into respective semantic terms. For example, the object label 95 associated with Individual 1 may be converted to a semantic term “BloodSugar::Normal”; the object label 130 associated with Individual 2 may be converted to a semantic term “BloodSugar:Diabetic”; and the object label 112 associated with Individual n may be converted to a semantic term “BloodSugar::Elevated”.

Also, for example, a performance of a medical procedure, such as open heart surgery, may be a category. The associated object label may indicate whether the procedure has been performed or not. In one example, such data may be represented as binary data. A “1” may indicate that the procedure has been performed, whereas a “0” may indicate that the procedure has not been performed. Converter 204 converts numeric data into respective semantic terms. For example, the object label “1” associated with Individual 1 may be converted to a semantic term “OpenHeartSurgery::Yes”; the object label “0” associated with Individual 2 may be converted to a semantic term “OpenHeartSurgery::No”; and the object label “1” associated with Individual n may be converted to a semantic term “OpenHeartSurgery::Yes”.

Referring again to FIG. 1, structured dataset 102 is converted via converter 104 to generate the structured dataset with sematic terms 106. As described herein, Label 11 is converted to semantic Term 11, Label 21 is converted to semantic term 21, and so forth.

System 100 includes an evaluator 108 to determine a term similarity for a pair of object labels in a given category, the term similarity being indicative of a correlation between the respective semantic terms in the given category. In one example, evaluator 108 may apply LSA to the structured dataset with sematic terms 106. Accordingly, an m×n “term-object” matrix M may be generated, where m is the total number of terms created for the entire dataset, and n is the number of objects. Mᵢⱼ, then, is the frequency count of term i in object j. Using Singular Value Decomposition, M may be represented as a product of three matrices:

M=UΣV^{T} (Eq. 1)

where U contains the eigenvectors for the term-term correlation matrix, V^{T} contains the eigenvectors for the document-document correlation matrix, and Σ is a diagonal matrix of singular values. By taking the k largest singular values in Σ, one can approximate M to a lower dimensional space by

Mₖ=UₖΣₖVₖ^{T} (Eq. 2)

Such a transformation reduces the sparseness of the original dataset so that terms that are co-located across several documents may be detected with relative ease. For example, the blood pressure medication propranolol can also be used to treat a heart rate condition like atrial fibrillation. In a sparse dataset with a relatively small sample size but large number of categories, such latent associations may not be found with relative ease. However, with LSA, the semantic correlation between the two terms propranolol and atrial fibrillation may be more easily inferred in the reduced data.

In one example, the evaluator 108 may determine an object similarity for a given pair of objects of the plurality of objects, the object similarity being based on the respective semantic terms for the given pair. In one example, the object similarity may be an aggregate of the respective term similarities. In one example, the object similarity may be a weighted average of the respective term similarities.

In one example, the object similarity for a given pair of objects may be determined based on a cosine between respective object vectors. The cosine measure may be utilized for object-object similarity measures. Generally, the object similarity may be less sensitively dependent on small changes in the structured dataset 102.

In one example, system 100 may include a classifier to classify the plurality of objects based on the respective term similarities. For example, a first threshold value may be determined and objects with term similarities that are within the first threshold value may be classified together, whereas objects with term similarities that are outside the first threshold value may not be classified together. For example, individuals with elevated blood sugar levels may be classified together. As another example, individuals with elevated blood sugar levels and normal hemoglobin levels may be classified together.

In one example, system 100 may include a classifier to classify the plurality of objects based on the respective object similarities. For example, a second threshold value may be determined and objects with cosine similarities that are within the second threshold value may be classified together, whereas objects with cosine similarities that are outside the second threshold value may not be classified together.

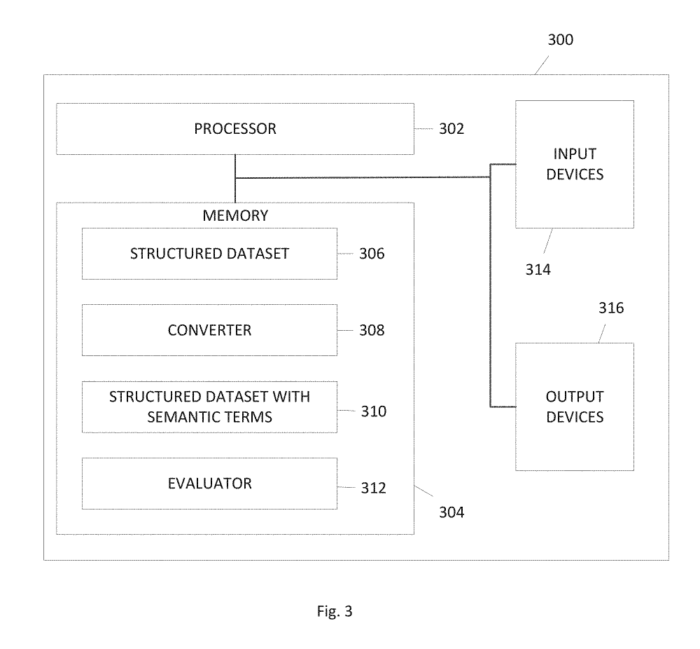

FIG. 3 is a block diagram illustrating one example of a processing system 300 for implementing the system 100 for detecting similarity in a structured dataset. Processing system 300 includes a processor 302, a memory 304, input devices 314, and output devices 316. Processor 302, memory 304, input devices 314, and output devices 316 are coupled to each other through communication link (e.g., a bus).

Processor 302 includes a Central Processing Unit (CPU) or another suitable processor. In one example, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory.

Memory 304 stores structured dataset 306 for processing by processing system 300. Memory 304 also stores instructions to be executed by processor 302 including instructions for a converter 308, and an evaluator 312. In one example, memory 304 also stores the structured dataset with semantic terms 310. In one example, converter 308, and evaluator 312, include converter 104, and evaluator 108, respectively, as previously described and illustrated with reference to FIG. 1.

In one example, processor 302 executes instructions of converter 308 to convert structured dataset 306 to provide the structured dataset with semantic terms 310. Processor 302 executes instructions of an evaluator 312 to determine a term similarity for a pair of object labels in a given category, the term similarity indicative of a correlation between the respective semantic terms in the given category. In one example, processor 302 executes instructions of an evaluator 312 to determine an object similarity for a given pair of objects of the plurality of objects, the object similarity based on the respective semantic terms for the given pair. In one example, the object similarity may be based on the cosine similarity between object vectors comprising semantic terms. In one example, processor 302 executes instructions of a classifier to classify the plurality of objects based on the term similarities, In one example, processor 302 executes instructions of a classifier to classify the plurality of objects based on the object similarities.

Input devices 314 include a keyboard, mouse, data ports, and/or other suitable devices for inputting information into processing system 300. In one example, input devices 314 are used to input a search query. For example, a user may input a query such as “find individuals with low hemoglobin count who are diabetic”. Output devices 316 include a monitor, speakers, data ports, and/or other suitable devices for outputting information from processing system 300. In one example, output devices 316 are used to provide responses to a search query. For example, in response to the search query “find individuals with low hemoglobin count who are diabetic”, output devices 316 may provide a list of individuals that satisfy the requirements of the search query. In one example, a classification query directed at an object is received via input devices 314. The processor 302 retrieves, from a database, a document class associated with the object, and provides such classification via output devices 316.

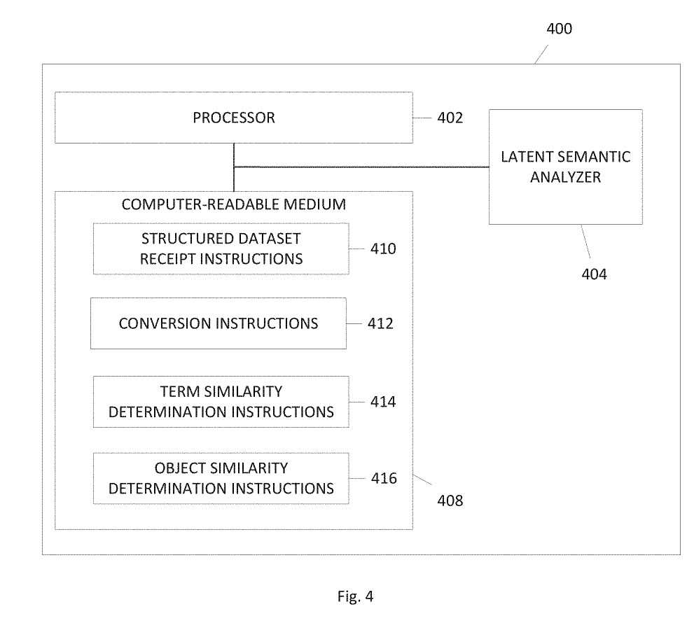

FIG. 4 is a block diagram illustrating one example of a computer readable medium for detecting similarity in a structured dataset. Processing system 400 includes a processor 402, a computer readable medium 408, and a latent semantic analyzer 404. Processor 402, computer readable medium 408, and the latent semantic analyzer 404 are coupled to each other through communication link (e.g., a bus).

Processor 402 executes instructions included in the computer readable medium 408. Computer readable medium 408 includes structured dataset receipt instructions 410 to receive a structured dataset. The structured dataset receipt instructions 410 include instructions to receive a plurality of objects, each object of the plurality of objects associated with a category, and each category associated with an object label. Computer readable medium 408 includes conversion instructions 412 of a converter to convert, for each object of the plurality of objects, the object label into a semantic term. In one example, the object label for each object of the plurality of objects may be numeric data, and computer readable medium 408 includes conversion instructions 412 of a converter to convert the numeric data into the semantic term based on a statistical distribution of object labels associated with the plurality of objects. In one example, the object label for each object of the plurality of objects may be procedural data, and computer readable medium 408 includes conversion instructions 412 of a converter to convert the procedural data into binary data.

Computer readable medium 408 includes term similarity determination instructions 414 of the latent semantic analyzer 404 to determine a term similarity for a pair of object labels in a given category, the term similarity indicative of a correlation between the respective semantic terms in the given category. Computer readable medium 408 includes object similarity determination instructions 414 of the latent semantic analyzer 404 to determine an object similarity for a given pair of objects of the plurality of objects, the object similarity based on the respective semantic terms for the given pair.

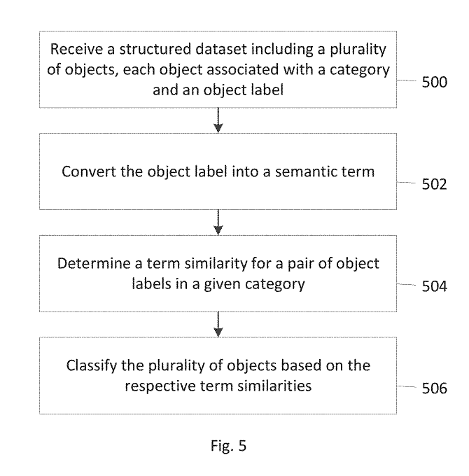

FIG. 5 is a flow diagram illustrating one example of a method for detecting similarity in a structured dataset. At 500, a structured dataset is received, the structured dataset including a plurality of objects, each object associated with a category and an object label. At 502, the object label is converted into a semantic term. At 504, a term similarity is determined for a pair of object labels in a given category. At 506, the plurality of objects is classified based on the term similarities.

In one example, the object label for each object of the plurality of objects may be numeric data, and converting the object label into the semantic term may be based on a statistical distribution of object labels associated with the plurality of objects.

In one example, the object label may be procedural data, and converting the object label into the semantic term may include converting the procedural data into binary data.

In one example, determining the term similarity may be based on latent semantic analysis.

In one example, a search query may be received via a processor, and an object of the plurality of objects may be provided based on the search query and the classification.

In one example, the plurality of objects may be a plurality of individuals, and the object label may be medical data.

Examples of the disclosure provide a generalized system for detecting similarity in a structured dataset. The generalized system provides an automatable approach to converting structured numeric data into semantic terms, and utilizing latent semantic analysis procedures to determine latent similarities within the structured dataset.

Although specific examples have been illustrated and described herein, especially as related to healthcare data, the examples illustrate applications to any structured data. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a structured dataset received via a processing system, the dataset comprising:
a plurality of objects,
each object of the plurality of objects associated with a category, and
each category associated with an object label;
a converter to convert, for each object of the plurality of objects, the object label into a semantic term; and
an evaluator to determine, via the processing system, a term similarity for a pair of object labels in a given category, the term similarity indicative of a correlation between the respective semantic terms in the given category.

2. The system of claim 1, wherein the object label for each object of the plurality of objects is numeric data, and the converter converts the numeric data into the semantic term based on a statistical distribution of object labels associated with the plurality of objects.

3. The system of claim 1, wherein the object label is procedural data, and the converter converts the procedural data into binary data.

4. The system of claim 1, wherein the evaluator determines the term similarity based on latent semantic analysis.

5. The system of claim 1, wherein the evaluator determines an object similarity for a given pair of objects of the plurality of objects, the object similarity based on the respective semantic terms for the given pair.

6. The system of claim 1, wherein the plurality of objects is a plurality of individuals, and the object label is healthcare data.

7. The system of claim 1, further including a classifier to classify the plurality of objects based on the respective term similarities.

8. A method to classify objects, the method comprising:
receiving, via a processor, a structured dataset comprising:
a plurality of objects,
each object of the plurality of objects associated with a category, and
each category associated with an object label;
converting, for each object of the plurality of objects, the object label into a semantic term;
determining, via the processor, a term similarity for a pair of object labels in a given category, the term similarity indicative of a correlation between the respective semantic terms in the given category; and
classifying the plurality of objects based on the respective term similarities.

9. The method of claim 8, wherein the object label for each object of the plurality of objects is numeric data, and converting the object label into the semantic term is based on a statistical distribution of object labels associated with the plurality of objects.

10. The method of claim 8, wherein the object label is procedural data, and converting the object label into the semantic term includes converting the procedural data into binary data.

11. The method of claim 8, wherein determining the term similarity is based on latent semantic analysis.

12. The method of claim 8, further comprising:
receiving a search query via the processor; and
providing an object of the plurality of objects based on the search query and the classification.

13. The method of claim 8, wherein the plurality of objects is a plurality of individuals, and the object label is healthcare data.

14. A non-transitory computer readable medium comprising executable instructions to:
receive, via a processor, a structured dataset comprising:
a plurality of objects,
each object of the plurality of objects associated with a category, and
each category associated with a numerical object label;
convert, for each object of the plurality of objects, the numerical object label into a semantic term;
determine, via the processor, a term similarity for a pair of object labels in a given category, the term similarity indicative of a correlation between the respective semantic terms in the given category; and
determine, via the processor, an object similarity for a given pair of objects of the plurality of objects, the object similarity based on the respective semantic terms for the given pair.

15. The non-transitory computer readable medium of claim 14, wherein determining the term similarity is based on latent semantic analysis.
